(19) United States
(12) Patent Application Publication
(10) Pub. No.: US 2017/0115655 A1
(43) Pub. Date: Apr. 27, 2017

(54) DIAGNOSTIC DEVICE AND DIAGNOSTIC METHOD

(71) Applicant: INSTITUTE FOR INFORMATION INDUSTRY, TAIPEI (TW)

(72) Inventors: Hung-Sheng Chiu, Taipei City (TW); Yung-Yi Huang, Nantou County (TW); Hung-An Kao, Taipei City (TW); Cheng-Hui Chen, Nantou County (TW); Jun-Ren Chen, Taichung City (TW); Hsiao-Chen Chang, Taipei City (TW)

(21) Appl. No.: 15/154,102

(22) Filed: May 13, 2016

(30) Foreign Application Priority Data
Oct. 27, 2015 (TW) 104135263

(51) Int. Cl. G05B 19/4065

(52) U.S. Cl. CPC G05B 19/4065; G05B 2219/34465

(57) ABSTRACT

A diagnostic device includes a data obtaining module and an analyzing module. The data obtaining module is configured to obtain a NC program block and receive condition data of an external device corresponds to the NC program block at the same time when the external device performs a NC program. The NC program block is a NC code of the NC program, the external device comprises a plurality of peripheral equipments, and the NC program block corresponds to at least one peripheral equipment of the peripheral equipments. If the condition data is abnormal, the analyzing module is configured to determine the at least one peripheral equipment of the peripheral equipments is abnormal based on the NC program block corresponding to the condition data which is abnormal.

### RELATED APPLICATIONS

This application claims priority to Taiwan Application Serial Number 104135263, filed Oct. 27, 2015, which is herein incorporated by reference.

### BACKGROUND

Field of Invention

The present invention relates to a diagnostic device and a diagnostic method. More particularly, the present invention relates to a diagnostic device and a diagnostic method for diagnosing machine tools.

Description of Related Art

Existing diagnostic method of a machine tool (for example, NC machine tools; the NC machine tools can be but not limited to milling machines, lathes, borers, lappers, drillers) is used to determine whether operation of the machine tool is abnormal, and give an alarm when the operation of the machine tool is abnormal. When a repairer hears/sees the alarm and notices that the operation of machine tool is abnormal, the repairer does not know which peripheral equipment in the machine tool is malfunction thereby leading the machine tool working abnormally because of there being many peripheral equipments in the machine tool. In this situation, the repairer needs to shut down the machine tool and check each peripheral equipment in the machine tool for determining which peripheral equipment is malfunction. Then, the repairer can repair the peripheral equipment. In view of above, the productivity of the machine tool decreases due to the shutdown time of the machine tools being prolonged.

For solving the problem mentioned above, there is a need to install sensors in each of the peripheral equipments in the machine tool to diagnose each of the peripheral equipments instantaneously for determining which peripheral equipment is malfunction. However, the cost of the machine tool increases, and there are extra processes for installing sensors in each of the peripheral equipments.

In view of the foregoing, problems and disadvantages are associated with existing products that require further improvement. However, those skilled in the art have yet to find a solution.

### SUMMARY

The following presents a simplified summary of the disclosure in order to provide a basic understanding to the reader. This summary is not an extensive overview of the disclosure and it does not identify key/critical elements of the present invention or delineate the scope of the present invention.

The present disclosure provides a diagnostic device and a diagnostic method for addressing the prior-art problem. The diagnostic device and the diagnostic method of the present disclosure are used to diagnose machine tools. However, the diagnostic device and the diagnostic method are not limited to diagnose machine tools. Actually, the diagnostic device and the diagnostic method can also diagnose other equipments needed to be diagnosed.

One aspect of the present disclosure is directed to a diagnostic device. The diagnostic device comprises a data obtaining module and an analyzing module. The data obtaining module is configured to obtain a NC program block and receive condition data of an external device corresponds to the NC program block at the same time when the external device performs a NC program. The NC program block is a NC code of the NC program, the external device comprises a plurality of peripheral equipments, and the NC program block corresponds to at least one peripheral equipment of the peripheral equipments. If the condition data is abnormal, the analyzing module is configured to determine the at least one peripheral equipment of the peripheral equipments is abnormal based on the NC program block corresponding to the condition data which is abnormal.

Another aspect of the present disclosure is directed to a diagnostic method. The diagnostic method comprises steps of: obtaining a NC program block and receive condition data of an external device corresponds to the NC program block at the same time by a data obtaining module when the external device performs a NC program, wherein the NC program block is a NC code of the NC program, the external device comprises a plurality of peripheral equipments, and the NC program block corresponds to at least one peripheral equipment of the peripheral equipments; and if the condition data is abnormal, determining the at least one peripheral equipment of the peripheral equipments is abnormal by an analyzing module based on the NC program block corresponding to the condition data which is abnormal.

In view of the foregoing, embodiments of the present disclosure provide a diagnostic device and a diagnostic method to determine which peripheral equipments in a device is abnormal based on the NC program block corresponding to the condition data which is abnormal. As such, there is no need to check each of the peripheral equipments via manual work; and therefore, the problems of productivity of machine tools decrease due to the shutdown time of the machine tools being prolonged. Furthermore, there is no need to install sensors in each of the peripheral equipments in the machine tool to diagnose each of the peripheral equipments instantaneously, such that the cost of the machine tool can be decreased, and processes of installing sensors in each of the peripheral equipments can be no longer needed.

These and other features, aspects, and advantages of the present invention, as well as the technical means and embodiments employed by the present invention, will become better understood with reference to the following description in connection with the accompanying drawings and appended claims.

### BRIEF DESCRIPTION OF THE DRAWINGS

The invention can be more fully understood by reading the following detailed description of the embodiment, with reference made to the accompanying drawings as follows:

FIG. 1 is a schematic diagram of a diagnostic device according to embodiments of the present invention;

FIG. 2 is a schematic diagram of a diagnostic device according to embodiments of the present invention;

FIG. 3 is a flow diagram illustrating the process steps of a diagnostic method according to embodiments of the present disclosure; and

FIG. 4 is a flow diagram illustrating the process steps of a diagnostic method according to embodiments of the present disclosure.

In accordance with common practice, the various described features/elements are not drawn to scale but instead are drawn to best illustrate specific features/elements relevant to the present invention. Also, wherever possible, like or the same reference numerals are used in the drawings and the description to refer to the same or like parts.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example.

However, the same or equivalent functions and sequences may be accomplished by different examples.

Unless otherwise defined herein, scientific and technical terminologies employed in the present disclosure shall have the meanings that are commonly understood and used by one of ordinary skill in the art. Unless otherwise required by context, it will be understood that singular terms shall include plural forms of the same and plural terms shall include singular forms of the same.

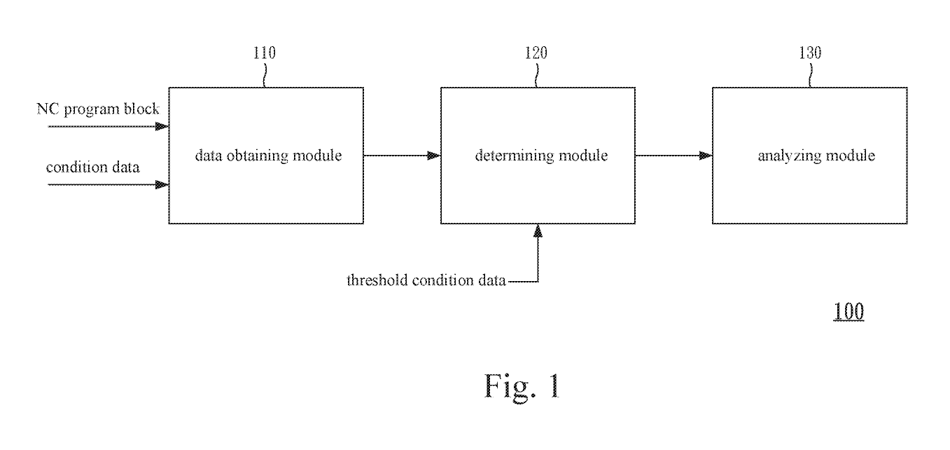

FIG. 1 is a schematic diagram of a diagnostic device according to embodiments of the present invention. As shown in the figure, the diagnostic device 100 comprises a data obtaining module 110 and an analyzing module 130. The data obtaining module 110 is configured to obtain a NC program block and receive condition data of an external device (not shown) corresponds to the NC program block at the same time when the external device performs a NC program. The NC program block is a NC code of the NC program. In addition, the external device comprises a plurality of peripheral equipments, and the NC program block corresponds to at least one peripheral equipment of the peripheral equipments. If the condition data is abnormal, the analyzing module 130 is configured to determine the at least one peripheral equipment of the peripheral equipments is abnormal based on the NC program block corresponding to the condition data which is abnormal. As mentioned above, the external device is the device which is needed to be diagnosed, for example, the external device can be all kinds of NC machine tools or processing machines. The NC machine tools comprise milling machines, lathes, borers, lappers, drillers, and so on, based on different processing manners. The peripheral equipments in the external device can be a spindle motor, a servomotor, a cooling pump, an oil-pressure gauge, a pump, an air compressor, a ball screw, a linear guideway, a screw, a nut, a frequency converter, a transformer, a PLC, an electromagnetic valve, and so on. The external device executes the NC program to perform processes. The condition data can be electricity consumption, or relative condition data of machine tools, for example, an idle shutdown, a working, an alarm shutdown, and so on.

In one embodiment, the NC program executed by the external device is as shown in table 1:

TABLE 1
NC program
NC program

| | |
|---|---|
| 1 | G00 X30 Z2 |
| 2 | G01 Z2.5 F200 |
| 3 | X26.75R1.5 |
| | Z-1.75 |

As shown in table 1, the NC program may comprise a plurality of NC program blocks, for example, the NC program may comprise a first group of the NC program block “G00 X30 Z2,” a second group of the NC program block “G01 Z2.5 F200” and a third group of the NC program block “X26.75R1.5 Z-1.75.” For facilitating understanding of the NC program block, the NC program block “G01 Z2.5 F200” in table 1 is described herein as an example. However, the present disclosure is not limited to the NC program as shown in table 1. The NC program is not only composed by the foregoing G Code (for example: G00, G01), but also composed by M Code, S Code, T Code. Each of the codes has a corresponding parameter, for example: coordinates, rotational speed, direction. The description of the codes and definition of the foregoing NC program block is as shown in table 2:

TABLE 2
comparison table of codes and definition

G00: move at max speed
G01: straight line cutting
X: X axis direction, horizontal direction
Y: Y axis direction, vertical direction
Z: Z axis direction, depth direction
Numbers behind XYZ: migration distance
F: speed of moving at feed rate

As shown in table 2, it can be seen that the definition of the second group of the NC program block “G01 Z2.5 F200” is that: “Z axis is moving at feed rate, distance is 2.5 inch, and speed is 200 mm/min.” In view of above, the codes of the NC program block are corresponding to peripheral equipments in the external device. As shown above, the NC program is not only composed by the G Code (for example: G00, G01), but also composed by M Code, S Code, or T Code. M code is used herein as an example. M07 represents “cutting oil ejection,” M08 represents “coolant on,” M09 represents “coolant off,” M15 represents “storage knife cover rising,” M16 represents “storage knife cover descending,” M25 represents “operation door automatic open,” M26 represents “operation door automatic close,” M57 represents “main shaft blow open,” M59 represents “main shaft blow close.” In addition, S code is used herein as an example. S function also called main shaft rotational speed function. With respect to AC spindle motor, the main shaft rotational speed can be controlled directly by the revolutions per minute (rpm) required by S. For example, if the value of the main shaft rotational speed is larger or less than the maximum or minimum rotational speed set by the manufacturer, the maximum or minimum rotational speed will be set to be the real rotational speed. For example, S1000 represents main shaft 1000 rpm, S2000 represents main shaft 2000 rpm, and so on. In addition, T code is used herein as an example. T represents “cutting tool function,” the number behind T represents “cutting tool number.” For example, T1 represents “changing into number 1 cutting tool,” and T2 represents “changing into number 2 cutting tool.”

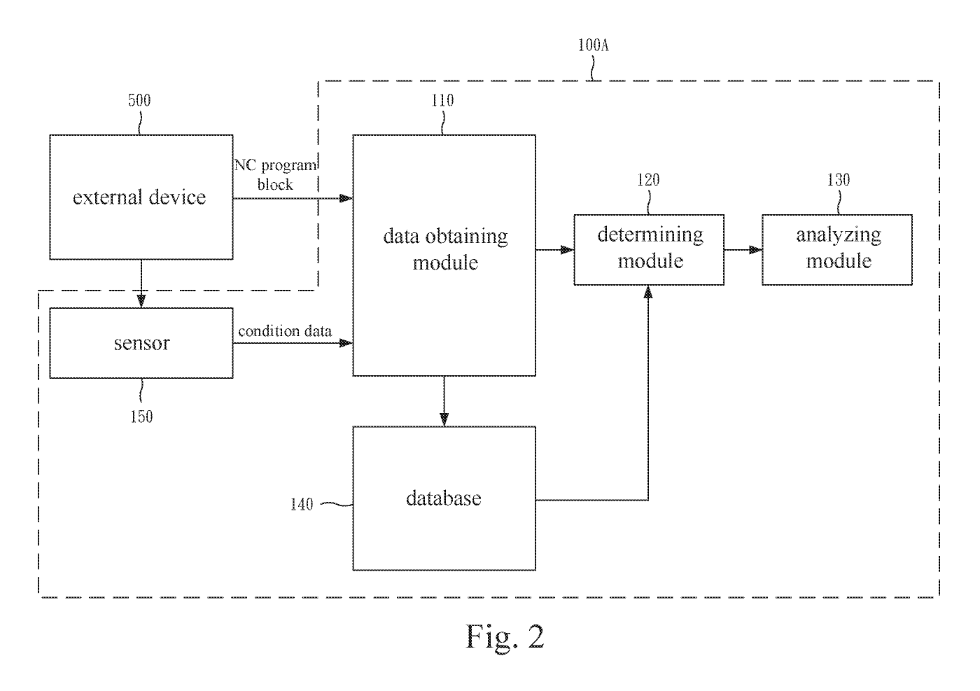

After understanding the definition of the NC program and the NC program block, the NC program block and the condition data of the external device corresponding thereto will be further described. Referring to table 3 below, it shows a comparison table of the NC program block and the condition data, and the comparison table can be stored in a database 140 (the database 140 will be described in the following FIG. 2):

TABLE 3
comparison table of NC program block and condition data

| | |
|---|---|
| NC program | condition data |

| | | | |
|---|---|---|---|
| 1 | G00 X30 Z2 | 100 | W (watt) |
| 2 | G01 Z2.5 F200 | 800 | W |
| 3 | X26.75R1.5 | 1500 | W |
| | Z-1.75 | | |

The data obtaining module 110 of the present disclosure can be used to receive the NC program block when the external device performs NC program. For example, the NC program block can be obtained through IO interface, for example: RJ45, RS-232, RS485, and so on. In addition, the data obtaining module 110 can receive the condition data of the external device corresponding to the NC program block at the same time; and therefore, owning to the foregoing operations, the comparison table of the NC program block and the condition data in table 3 can be obtained. If the condition data is abnormal, for example, the electricity consumption is overhigh (for example, 800 W), the analyzing module 130 can correspondingly fine out the second group of the NC program block at left side of the table 3 based on the overhigh information of the electricity consumption at right side of the table 3. Subsequently, the codes of the NC program block correspond to the peripheral equipments of the external device; and therefore, the analyzing module 130 can diagnose which one of the peripheral equipments in the external device is abnormal through the NC program block. As such, there is no need to check each of the relative components via manual work; and therefore, the problems of productivity of machine tools decreasing due to the shutdown time of the machine tools being prolonged can be improved. Furthermore, there is no need to install sensors in each of the peripheral equipments in the machine tool to diagnose each of the peripheral equipments instantaneously, such that the cost of the machine tool can be decreased, and processes of installing sensors in each of the peripheral equipments can be no longer needed.

Moreover, in another embodiment, the diagnostic device 100 further comprises a determining module 120 (referring to FIG. 1). The determining module 120 is configured to obtain a threshold condition data from a database (not shown), and compare the condition data and the threshold condition data for determining whether the condition data is abnormal. For example, the determining module 120 may obtain the threshold condition data corresponding to the second group of the NC program block in table 3 from the database. The threshold condition data is electricity consumption 500 W. However, in fact, the condition data of the second group of the NC program block is electricity consumption 800 W. Hence, it is determined that the second group of the NC program block is abnormal after the determining module 120 compares the condition data of the second group of the NC program block and the threshold condition data. In other word, the electricity consumption of the second group of the NC program block is actually overhigh.

FIG. 2 is a schematic diagram of a diagnostic device according to embodiments of the present invention. Compared with the diagnostic device 100 in FIG. 1, the diagnostic device 100A herein further comprises a database 140 and a sensor 150. As shown in FIG. 2, the data obtaining module 110 of the diagnostic device 100A is configured to obtain a NC program block and receive condition data of an external device 500 corresponds to the NC program block at the same time when the external device 500 performs a NC program. The condition data which is corresponding to the NC program block can be obtained by sensing the external device 500 via the sensor 150 which is coupled to the external device 500. The condition data is, for example, an instantaneous maximum value, an average consumption value or an accumulation consumption value. If the condition data is abnormal, the analyzing module 130 is configured to determine which one of the peripheral equipments in the external device 500 is abnormal based on the NC program block corresponding to the condition data which is abnormal.

In one embodiment, the sensor 150 comprises a current transformer. The current transformer is coupled to the external device 500, and configured to sense an instantaneous maximum value of electricity consumption corresponding to the NC program block. The instantaneous maximum value of electricity consumption is regard as the condition data. In addition, the determining module 120 obtains a threshold electricity consumption value from the database 140 according to the NC program block, and compares the instantaneous maximum value of the electricity consumption and the threshold electricity consumption value for determining whether the instantaneous maximum value of the electricity consumption is abnormal. If the instantaneous maximum value of the electricity consumption is abnormal, the analyzing module 130 determines which one of the peripheral equipments in the external device 500 corresponding to the NC program block is abnormal according to the NC program block corresponding to the instantaneous maximum value of the electricity consumption which is abnormal.

For example, referring to table 3, the threshold electricity consumption value of the second group of the NC program block obtained by the determining module 120 from the database 140 is 500 W. However, as shown in table 3, the instantaneous maximum value of the electricity consumption of the second group of the NC program block is 800 W. Hence, it is determined that the instantaneous maximum value of the electricity consumption of the second group of the NC program block is overhigh by the determining module 120 after the determining module 120 compares the instantaneous maximum value of the electricity consumption of the second group of the NC program block and the threshold electricity consumption value. That is to say, the instantaneous maximum value of the electricity consumption of the second group of the NC program block is actually overhigh.

In another embodiment, the sensor 150 comprises an accelerometer. The accelerometer is coupled to the external device 500 and configured to sense an instantaneous maximum value of vibration corresponding to the NC program block. In addition, the determining module 120 obtains a threshold vibration value from the database 140 according to the NC program block, and compares the instantaneous maximum value of the vibration and the threshold vibration value for determining whether the instantaneous maximum value of the vibration is abnormal. If the instantaneous maximum value of the vibration is abnormal, the analyzing module 130 determines which one of the peripheral equipments in the external device 500 corresponding to the NC program block is abnormal according to the NC program block corresponding to the instantaneous maximum value of the vibration which is abnormal.

In still another embodiment, the sensor 150 comprises a sound sensor, a temperature and humidity sensor, a gyroscope sensor, a laser ranging sensor, and so on. The sensors are coupled to the external device 500, and used for sensing all kinds of condition data corresponding to the NC program block. Subsequently, the determining module 120 determines whether the condition data is abnormal, and the analyzing module 130 determines which one of the peripheral equipments in the external device 500 corresponding to the NC program block is abnormal according to the condition data corresponding to the NC program block which is abnormal.

In another embodiment, the database 140 may establish original database files based on condition data which is corresponding to the NC program block and the NC program block obtained by the data obtaining module 110 constantly. For example, the data obtaining module 110 obtains each NC program block and condition data corresponding to the NC program block when each time the external device 500 performs the NC program. The foregoing condition data will be accumulated to establish the original database files. For example, when the determining module 120 determines that condition data is not abnormal, the data obtaining module 110 may store the NC program block and condition data which is corresponding to the NC program block into the database 140. In view of above, the database 140 may accumulate condition data corresponding to each NC program block when condition data is normal. Subsequently, the accumulated condition data can be calculated to obtain the threshold condition data when the external device 500 operates normally.

In another embodiment, the database 140 may update data therein based on the NC program block and condition data corresponding to the NC program block obtained by the data obtaining module 110. For example, the data obtaining module 110 obtains each NC program block and condition data corresponding to the NC program block when each time the external device 500 performs the NC program for updating data stored in the database 140 constantly. For example, when the determining module 120 determines that condition data is not abnormal, the data obtaining module 110 may store the NC program block and condition data which is corresponding to the NC program block into the database 140. In view of above, the database 140 may accumulate condition data corresponding to each NC program block when condition data is normal. Subsequently, the accumulated condition data can be calculated to obtain the threshold condition data when the external device 500 operates normally, such that the threshold condition data when the external device 500 operates normally can be adjusted adaptively thereby facilitating determination of the operation condition of the external device 500.

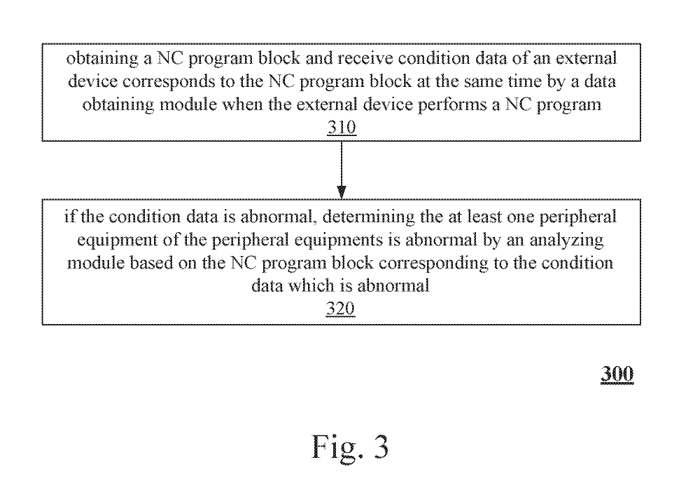

FIG. 3 is a flow diagram illustrating the process steps of a diagnostic method according to embodiments of the present disclosure. As shown in the figure, the diagnostic method 300 of the present disclosure comprises steps as shown below:

Step 310: obtaining a NC program block and receive condition data of an external device corresponds to the NC program block at the same time by a data obtaining module when the external device performs a NC program; and

Step 320: if the condition data is abnormal, determining the at least one peripheral equipment of the peripheral equipments is abnormal by an analyzing module based on the NC program block corresponding to the condition data which is abnormal.

For facilitating understanding of the diagnostic method 300 of the embodiment of the present disclosure, reference is now made to both FIG. 1 and FIG. 3. In step 310, when the external device (not shown) performs a NC program, the data obtaining module 110 is configured to obtain the NC program block, for example, NC program block can be obtained through IO interface (for example: RJ45, RS-232, RS485, and so on). In addition, the data obtaining module 110 can receive the condition data of the external device corresponding to NC program block at the same time. The NC program block is a NC code of the NC program. In addition, the external device comprises a plurality of peripheral equipments, and the NC program block corresponds to at least one peripheral equipment of the peripheral equipments. As mentioned above, the external device is the device which is needed to be diagnosed, for example, the external device can be all kinds of NC machine tools or processing machines. The NC machine tools comprise milling machines, lathes, borers, lappers, drillers, and so on, based on different processing manners. The peripheral equipments in the external device can be a spindle motor, a servomotor, a cooling pump, an oil-pressure gauge, a pump, an air compressor, a ball screw, a linear guideway, a screw, a nut, a frequency converter, a transformer, a PLC, an electromagnetic valve, and so on. The external device executes the NC program to perform processes. The condition data can be electricity consumption, or relative condition data of machine tools, for example, an idle shutdown, a cutting, an alarm shutdown, and so on.

In step 320, if the condition data is abnormal, the analyzing module 130 is configured to determine the at least one peripheral equipment of the peripheral equipments is abnormal based on the NC program block corresponding to the condition data which is abnormal.

In one embodiment, the step 320 comprises: the analyzing module 130 determines the at least one peripheral equipment of the peripheral equipments corresponding to the code is abnormal based on the code of the NC program block corresponding to the condition data which is abnormal.

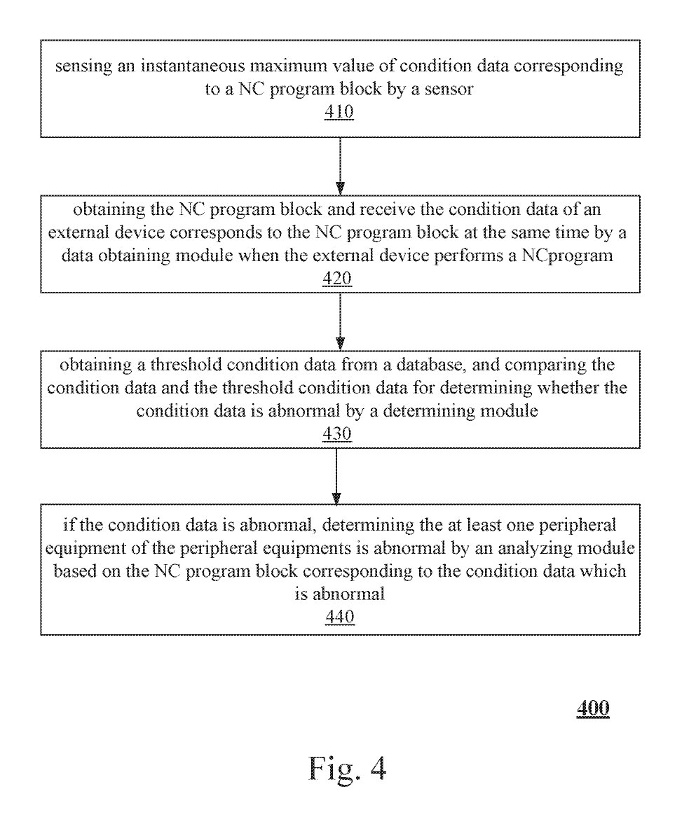

FIG. 4 is a flow diagram illustrating the process steps of a diagnostic method according to embodiments of the present disclosure. As shown in the figure, the diagnostic method 400 of the present disclosure comprises steps as shown below:

Step 410: sensing an instantaneous maximum value of the condition data corresponding to the NC program block by a sensor;

Step 420: obtaining a NC program block and receive condition data of an external device corresponds to the NC program block at the same time by a data obtaining module when the external device performs a NC program;

Step 430: obtaining a threshold condition data from a database, and comparing the condition data and the threshold condition data for determining whether the condition data is abnormal by a determining module; and

Step 440: if the condition data is abnormal, determining the at least one peripheral equipment of the peripheral equipments is abnormal by an analyzing module based on the NC program block corresponding to the condition data which is abnormal.

For facilitating understanding of the diagnostic method 400 of the embodiment of the present disclosure, reference is now made to both FIG. 2 and FIG. 4. In step 410, a sensor 150 is configured to sense the condition data corresponding to the NC program block. The condition data is, for example, an instantaneous maximum value, an average consumption value or an accumulation consumption value. The sensor 150 is coupled to the external device 500. The external device 500 is the device which is needed to be diagnosed, for example, the external device 500 can be all kinds of NC machine tools or processing machines. The NC machine tools comprise milling machines, lathes, borers, lappers, drillers, and so on, based on different processing manners. The peripheral equipments in the external device can be a spindle motor, a servomotor, a cooling pump, an oil-pressure gauge, a pump, an air compressor, a ball screw, a linear guideway, a screw, a nut, a frequency converter, a transformer, a PLC, an electromagnetic valve, and so on. The external device executes the NC program to perform processes. The condition data can be electricity consumption, or relative condition data of machine tools, for example, an idle shutdown, a cutting, an alarm shutdown, and so on

In step 420, when the external device 500 performs the NC program, the data obtaining module 110 is configured to obtain the NC program block, for example, NC program block can be obtained through IO interface (for example: RJ45, RS-232, RS485, and so on). In addition, the data obtaining module 110 can receive the condition data of the external device 500 corresponding to NC program block at the same time. The NC program block is a NC code of the NC program. In addition, the external device 500 comprises a plurality of peripheral equipments, and the NC program block corresponds to at least one peripheral equipment of the peripheral equipments.

In step 430, the determining module 120 obtains a threshold condition data from the database 140, and compares the condition data and the threshold condition data for determining whether the condition data is abnormal.

In step 440, If the condition data is abnormal, the analyzing module 130 is configured to determine the at least one peripheral equipment of the peripheral equipments is abnormal based on the NC program block corresponding to the condition data which is abnormal.

Referring to both FIG. 2 and FIG. 4, in one embodiment, the diagnostic method 400 of the embodiment of the present disclosure further comprises step as shown below: sensing an instantaneous maximum value of electricity consumption corresponding to the NC program block by a current transformer, and the instantaneous maximum value of electricity consumption is regard as the condition data; and then, obtaining a threshold electricity consumption value from the database 140 according to the NC program block, and comparing the instantaneous maximum value of the electricity consumption and the threshold electricity consumption value for determining whether the instantaneous maximum value of the electricity consumption is abnormal by the determining module 120; if the instantaneous maximum value of the electricity consumption is abnormal, the analyzing module 130 determines whether at least one peripheral equipment of the peripheral equipments corresponding to the NC program block is abnormal according to the NC program block corresponding to the instantaneous maximum value of the electricity consumption which is abnormal.

Referring to both FIG. 2 and FIG. 4, in another embodiment, the diagnostic method 400 of the embodiment of the present disclosure further comprises step as shown below: sensing an instantaneous maximum value of vibration by an accelerometer corresponding to the NC program block; and obtaining a threshold vibration value from the database 140 according to the NC program block, and comparing the instantaneous maximum value of the vibration and the threshold vibration value for determining whether the instantaneous maximum value of the vibration is abnormal by the determining module 120; if the instantaneous maximum value of the vibration is abnormal, the analyzing module 130 determines whether at least one peripheral equipment of the peripheral equipments corresponding to the NC program block is abnormal according to the NC program block corresponding to the instantaneous maximum value of the vibration which is abnormal.

In still another embodiment, the diagnostic method 400 of the embodiment of the present disclosure further comprises step as shown below: sensing all kinds of condition data corresponding to the NC program block by a sound sensor, a temperature and humidity sensor, a gyroscope sensor, a laser ranging sensor, and so on; and then, the determining module 120 determines whether the condition data is abnormal, and the analyzing module 130 determines which one of the peripheral equipments in the external device 500 corresponding to the NC program block is abnormal according to the condition data corresponding to the NC program block which is abnormal.

Referring to both FIG. 2 and FIG. 4, in another embodiment, the diagnostic method 400 of the embodiment of the present disclosure further comprises step as shown below: the database 140 may establish original database files based on condition data which is corresponding to the NC program block and the NC program block obtained by the data obtaining module 110 constantly. For example, the data obtaining module 110 obtains each NC program block and condition data corresponding to the NC program block when each time the external device 500 performs the NC program. The foregoing condition data will be accumulated to establish the original database files. For example, when the determining module 120 determines that condition data is not abnormal, the data obtaining module 110 may store the NC program block and condition data which is corresponding to the NC program block into the database 140. In view of above, the database 140 may accumulate condition data corresponding to each NC program block when condition data is normal. Subsequently, the accumulated condition data can be calculated to obtain the threshold condition data when the external device 500 operates normally.

Referring to both FIG. 2 and FIG. 4, in yet another embodiment, the diagnostic method 400 of the embodiment of the present disclosure further comprises step as shown below: the database 140 may update data therein based on the NC program block and condition data corresponding to the NC program block obtained by the data obtaining module 110. For example, the data obtaining module 110 obtains each NC program block and condition data corresponding to the NC program block when each time the external device 500 performs the NC program for updating data stored in the database 140 constantly. For example, when the determining module 120 determines that condition data is not abnormal, the data obtaining module 110 may store the NC program block and condition data which is corresponding to NC program block into the database 140. In view of above, the database 140 may accumulate condition data corresponding to each NC program block when condition data is normal. Subsequently, the accumulated condition data can be calculated to obtain the threshold condition data when the external device 500 operates normally, such that the threshold condition data when the external device 500 operates normally can be adjusted adaptively thereby facilitating determination of the operation condition of the external device 500.

Further, as may be appreciated by persons having ordinary skill in the art, the steps of diagnostic device are named according to the function they perform, and such naming is provided to facilitate the understanding of the present disclosure but not to limit the steps. Combining the step into a single step or dividing any one of the steps into multiple steps, or switching any step so as to be a part of another step falls within the scope of the embodiments of the present disclosure.

In view of the above embodiments of the present disclosure, it is apparent that the application of the present invention has the advantages as follows. The embodiment of the present disclosure provides a diagnostic device and a diagnostic method to determine which peripheral equipments in a machine tool is abnormal based on the NC program block corresponding to the condition data which is abnormal. As such, there is no need to check each of the peripheral equipments via manual work; and therefore, the problems of productivity of machine tools decrease due to the shutdown time of the machine tools being prolonged can be improved. Furthermore, there is no need to install sensors in each of the peripheral equipments in the machine tool to diagnose each of the peripheral equipments instantaneously, such that the cost of the machine tool can be decreased, and processes of installing sensors in each of the peripheral equipments can be no longer needed.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A diagnostic device, comprising:
a data obtaining module configured to obtain a NC program block and receive condition data of an external device corresponds to the NC program block at the same time when the external device performs a NC program, wherein the NC program block is a NC code of the NC program, the external device comprises a plurality of peripheral equipments, and the NC program block corresponds to at least one peripheral equipment of the peripheral equipments; and
an analyzing module, if the condition data is abnormal, the analyzing module configured to determine the at least one peripheral equipment of the peripheral equipments is abnormal based on the NC program block corresponding to the condition data which is abnormal.

2. The diagnostic device of claim 1, wherein the NC program block further comprises a plurality of codes, each of the codes corresponds to at least one peripheral equipment of the peripheral equipments of the external device, wherein the analyzing module determines the at least one peripheral equipment of the peripheral equipments corresponding to the code is abnormal based on the code of the NC program block corresponding to the condition data which is abnormal.

3. The diagnostic device of claim 1, further comprising:
a determining module configured to obtain a threshold condition data from a database, and compare the condition data and the threshold condition data for determining whether the condition data is abnormal.

4. The diagnostic device of claim 3, wherein the database updates data stored in the database based on the NC program block and the condition data corresponding to the NC program block obtained by the data obtaining module.

5. The diagnostic device of claim 1, further comprising:
a sensor coupled to the external device and configured to sense an instantaneous maximum value of the condition data corresponding to the NC program block.

6. The diagnostic device of claim 3, further comprising:
a current transformer coupled to the external device and configured to sense an instantaneous maximum value of electricity consumption corresponding to the NC program block, wherein the determining module obtains a threshold electricity consumption value from the database according to the NC program block, and compares the instantaneous maximum value of the electricity consumption and the threshold electricity consumption value for determining whether the instantaneous maximum value of the electricity consumption is abnormal,
if the instantaneous maximum value of the electricity consumption is abnormal, the analyzing module determines whether at least one peripheral equipment of the peripheral equipments corresponding to the NC program block is abnormal according to the NC program block corresponding to the instantaneous maximum value of the electricity consumption which is abnormal.

7. The diagnostic device of claim 3, further comprising:
an accelerometer coupled to the external device and configured to sense an instantaneous maximum value of vibration corresponding to the NC program block, wherein the determining module obtains a threshold vibration value from the database according to the NC program block, and compares the instantaneous maximum value of the vibration and the threshold vibration value for determining whether the instantaneous maximum value of the vibration is abnormal,
if the instantaneous maximum value of the vibration is abnormal, the analyzing module determines whether at least one peripheral equipment of the peripheral equipments corresponding to the NC program block is abnormal according to the NC program block corresponding to the instantaneous maximum value of the vibration which is abnormal.

8. A diagnostic method, comprising:
obtaining a NC program block and receive condition data of an external device corresponds to the NC program block at the same time by a data obtaining module when the external device performs a NC program, wherein the NC program block is a NC code of the NC program, the external device comprises a plurality of peripheral equipments, and the NC program block corresponds to at least one peripheral equipment of the peripheral equipments; and
if the condition data is abnormal, determining the at least one peripheral equipment of the peripheral equipments is abnormal by an analyzing module based on the NC program block corresponding to the condition data which is abnormal.

9. The diagnostic method of claim 8, wherein the NC program block comprises a plurality of codes, each of the codes corresponds to at least one peripheral equipment of the peripheral equipments of the external device, wherein determining the at least one peripheral equipment of the peripheral equipments is abnormal by the analyzing module based on the NC program block corresponding to the condition data which is abnormal comprising:
the analyzing module determining the at least one peripheral equipment of the peripheral equipments corresponding to the code is abnormal based on the code of the NC program block corresponding to the condition data which is abnormal.

10. The diagnostic method of claim 8, further comprising:
obtaining a threshold condition data from a database, and comparing the condition data and the threshold condition data for determining whether the condition data is abnormal by a determining module.

11. The diagnostic method of claim 10, further comprising:
updating data stored in the database based on the NC program block and the condition data corresponding to the NC program block obtained by the data obtaining module.

12. The diagnostic method of claim 8, further comprising:
sensing an instantaneous maximum value of the condition data corresponding to the NC program block by a sensor, wherein the sensor is coupled to the external device.

13. The diagnostic method of claim 10, further comprising:
sensing an instantaneous maximum value of electricity consumption corresponding to the NC program block by a current transformer; and
obtaining a threshold electricity consumption value from the database according to the NC program block, and comparing the instantaneous maximum value of the electricity consumption and the threshold electricity consumption value for determining whether the instantaneous maximum value of the electricity consumption is abnormal by the determining module, if the instantaneous maximum value of the electricity consumption is abnormal, the analyzing module determines whether at least one peripheral equipment of the peripheral equipments corresponding to the NC program block is abnormal according to the NC program block corresponding to the instantaneous maximum value of the electricity consumption which is abnormal.

14. The diagnostic method of claim 10, further comprising:
sensing an instantaneous maximum value of vibration by an accelerometer corresponding to the NC program block; and
obtaining a threshold vibration value from the database according to the NC program block, and comparing the instantaneous maximum value of the vibration and the threshold vibration value for determining whether the instantaneous maximum value of the vibration is abnormal by the determining module, if the instantaneous maximum value of the vibration is abnormal, the analyzing module determines whether at least one peripheral equipment of the peripheral equipments corresponding to the NC program block is abnormal according to the NC program block corresponding to the instantaneous maximum value of the vibration which is abnormal.
